(19) United States
(12) Patent Application Publication
(10) Pub. No.: US 2026/0173089 A1
(43) Pub. Date: Jun. 18, 2026

(54) CELL SWITCHING COMMAND FOR LAYER 1/LAYER 2 TRIGGERED MOBILITY IN WIRELESS COMMUNICATION

(71) Applicant: Apple Inc., Cupertino, CA (US)

(72) Inventors: Hong He, San Jose, CA (US); Oghenekome Oteri, San Diego, CA (US); Sigen Ye, San Diego, CA (US); Qiming LI, Beijing (CN); Dawei Zhang, Saratoga, CA (US); Jie CUI, San Jose, CA (US); Chunxuan Ye, San Diego, CA (US); Weidong Yang, San Diego, CA (US); Wei Zeng, Saratoga, CA (US)

(21) Appl. No.: 19/125,095

(22) PCT Filed: Nov. 4, 2022
(86) PCT No.: PCT/CN2022/129828

§ 371 Date: Apr. 28, 2025

(51) Int. Cl. H04W 72/23; H04W 74/0838; H04W 76/38

(52) U.S. Cl. CPC H04W 72/23; H04W 74/0838; H04W 76/38

(57) ABSTRACT

Systems and methods are for determining a transmission configuration indicator (TCI) state for a target cell, the TCI state specified in a medium access control (MAC) control element (CE) that identifies the target cell and a cell group (CG) of the target cell, the target cell being a candidate cell for a switch in a L1/L2-Triggered Mobility (LTM) scenario; activating a TCI state that is configured for the target cell in the target CG based on the determined TCI state indicator of the MAC-CE; and receiving a PDSCH or PDCCH transmission from the target cell of the target CG based on the activated TCI state.

### BACKGROUND

Wireless communication networks provide integrated communication platforms and telecommunication services to wireless user devices. Example telecommunication services include telephony, data (e.g., voice, audio, and/or video data), messaging, internet-access, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include code division multiple access (CDMA) networks, time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

### SUMMARY

The devices, systems, and methods described in this document are configured for mobility enhancement for wireless devices, such as user equipment (UE) in wireless networks. Specifically, the methods described herein include cell handover command (e.g., a cell switching command) including particular fields (described in detail below) to manage cell switching during mobility scenarios. The command includes an enhanced Layer 1/Layer 2 (L 1/L2) Triggered Mobility (LTM) procedure to improve Layer 3 inter-cell mobility.

The L1 enhancements of the systems and processes described herein are configured to provide several advantages, further described below. The LTM procedure is configured to indicate the beam information association with the target cells, without requiring configuration of all potential target TCI states. The processes described here are configured to overcome the drawback to Rel-17 ICBM, which relies on a configuration of all potential target TCI states for the serving cell and target cells (non-serving cells). The potential target cells include neighbor cells to the serving cell. Generally, Rel-17 ICBM does not consider mobility use scenarios. In some mobility use scenarios, the UE can be configured with a large number of TCI States for candidate cells measurement and significantly impact TCI states for the current intra-frequency serving cell. The LTM procedures described herein can overcome a factor in which there are limited number of TCI states available (e.g., 64). This factor is overcome because the LTM procedure does not configure all potential target TCI states. The LTM procedures described herein enable mobility scenarios because it does not require using TCI states for all neighboring cells (non-serving cells) or substantially reducing a number of TCI states available for the serving cell. The LTM procedures also enable mobility scenarios under Rel-18, in which a large number of target or neighboring cells are selected as candidates, without substantially reducing the available TCI states for the active serving cell.

The systems and processes are configured to avoid or reduce a latency caused after handover by the LTM procedure The systems and processes for the LTM procedure described herein reduce a downlink (DL) synchronization and beam refinement latency for the Physical Data Shared Channel (PDSCH) by introducing an aperiodic signal triggered by the LTM procedure ensure DL T/F synchronization and beam refinement occur with minimal latency and therefore minimal impact on DL synchronization.

In accordance with one aspect of the present disclosure, a process includes receiving a medium access control (MAC) control element (CE) specifying a transmission configuration indicator (TCI) state for a target cell, the MAC CE further identifying the target cell and a cell group (CG) of the target cell, the target cell being a candidate cell for a switch in a L1/L2-Triggered Mobility (LTM) scenario. The process includes activating a TCI state that is configured for the target cell in the target CG based on the specified TCI state of the MAC-CE. The process includes receiving a PDSCH or PDCCH transmission from the target cell of the target CG based on the activated TCI state.

In some implementations, the MAC CE comprises a bitmap that specifies, for each bit of the bitmap, activation of the TCI state with a TCI state identifier value corresponding to the index of that bit in the bitmap, the activation comprising mapping the activated TCI state with the TCI state identifier value to a codepoint of TCI field in a downlink control information (DCI).

In some implementations, the MAC CE comprises a bandwidth part identifier that indicates a downlink bandwidth part of the target cell for which the MAC CE is applicable.

In some implementations, the MAC CE is used to support activating one or more TCI states for a target cell when at least two candidate cell groups are configured for LTM scenario, each candidate cell group comprising up to 32 deactivated candidate target cells.

In some implementations, the MAC CE is used to support activating one or more TCI states for a target cell when at least four candidate cell groups are configured for LTM procedure, each candidate cell group comprising up to 16 deactivated candidate target cells.

In some implementations, the MAC CE comprises a CORESET ID field that indicates a CORESET identifier value for a predefined BWP for the target cell.

In some implementations, the MAC CE comprises a TCI state ID field, wherein the TCI state ID is configured by radio resource control (RRC) signaling for the target cell.

In some implementations, the TCI state ID field is 7 bits.

In some implementations, a spatial setting for a PUCCH/PUSCH transmission from a UE matches a spatial setting for PDCCH receptions at the UE in the lowest CORESETs of a first active BWP during a L1/L2 triggered mobility (LTM) operation.

In some implementations, the MAC CE comprises a spatial relation information (SRI) field that specifies spatial relation information for a PUCCH resource for transmission by a UE.

In some implementations, the MAC CE comprises: a BWP ID field that indicates a BWP where the MAC-CE is applied; and a TCI state identifier field that indicates a TCI state associated with a given codepoint of a TCI field and applied for the indicated BWP, the TCI identifier field being associated with an DL or UL field that indicates whether the TCI state is associated with a downlink TCI state or an uplink TCI state.

In some implementations, the MAC CE comprises a P field that indicates whether the given codepoint is associated with a single TCI state or multiple TCI states.

In some implementations, the process includes triggering a cell switch based on a cell switching command (CSC), the cell switching command comprising a cell group identifier field indicating a cell group, and a target SpCell identifier field indicating the target SpCell in the cell group.

In some implementations, the CSC further includes a bitmap field indicating the activation or deactivation of each cell in the cell group. In some implementations, the CSC includes a BWP ID field indicating an identity of at least one bandwidth part that is applied on the indicated target SpCell for LTM operation.

In some implementations, a first active downlink BWP and a first active uplink BWP that are configured by RRC signaling during a preparation phase for LTM operation are used during and after LTM operation for communication with the target cell.

In some implementations, the CSC further includes a beam information field applied for the SpCell in the cell group that is identified.

In some implementations, the beam information field indicates a TCI state from one or more activated TCI states associated with the target cell.

In some implementations, the beam information field indicates a Reference Signal (RS) index from one or more RSs that is used for target cell measurement and report.

In some implementations, the CSC further includes a timing advance field that includes a timing advance (TA) value or time advance group (TAG) value.

In some implementations, the process includes providing, to a UE, a set of contention free random access (CFRA) configurations by RRC signaling on a SpCell in each cell group as part of a cell group configuration. In some implementations, the process includes providing, in a CSC to the UE, a CFRA configuration index for a SpCell of the cell group. In some implementations, the process includes triggering a CFRA procedure based on the CFRA configuration associated with the indicated CFRA configuration index to acquire a timing advance value during the LTM operation.

In a general aspect, a process includes providing, to a UE, one or more tracking reference signal TRS resource set bursts for a cell or for a SpCell only in a candidate cell group. The process includes triggering, based on TRS request field in a cell switching command (CSC) signal, an aperiodic TRS burst transmission.

In some implementations, the TRS request field includes a non-zero value that indicates a TRS ID that specifies the TRS resource burst transmission that is triggered.

In some implementations, a gap between bursts of the TRS resource sets is configured by a separate radio resource control parameter in a unit of slots.

In some implementations, a triggering offset, between a slot of the CSC signal and a slot in which the TRS resource set burst is transmitted, is configured by RRC based on a UE capability report.

In some implementations, one or more non-transitory computer-readable media including instructions to cause an electronic device, upon execution of the instructions by one or more processors of the electronic device, to perform one or more elements of a process described in or related to any of the foregoing implementations, or any other method or process described herein.

In some implementations, an apparatus including logic, modules, or circuitry to perform one or more elements of a method described in or related to any of the foregoing implementations, or any other method or process described herein.

In some implementations, an apparatus includes one or more processors and one or more computer-readable media including instructions that, when executed by the one or more processors, cause the one or more processors to perform the method, techniques, or process as described in or related to any of the foregoing implementations, or portions thereof.

In some implementations, a signal is used as described in or related to any of the foregoing implementations, or portions or parts thereof.

In some implementations, a datagram, information element, packet, frame, segment, PDU, or message is used as described in or related to any of the foregoing implementations, or portions or parts thereof, or otherwise described in the present disclosure.

In some implementations, a signal is encoded with data as described in or related to any of the foregoing implementations, or portions or parts thereof, or otherwise described in the present disclosure.

In some implementations, a signal is encoded with a datagram, IE, packet, frame, segment, PDU, or message as described in or related to any of the foregoing implementations, or portions or parts thereof, or otherwise described in the present disclosure.

In some implementations, an electromagnetic signal is carrying computer-readable instructions, wherein execution of the computer-readable instructions by one or more processors is to cause the one or more processors to perform the method, techniques, or process as described in or related to any of the foregoing implementations, or portions thereof.

In some implementations, a computer program includes instructions, wherein execution of the program by a processing element is to cause the processing element to carry out the method, techniques, or process as described in or related to any of the foregoing implementations, or portions thereof. The operations or actions performed by the instructions executed by the processing element can include the methods of any of the foregoing implementations.

In some implementations, a system provides a wireless communication as shown and described herein. The operations or actions performed by the system can include the methods of any of the foregoing implementations.

In some implementations, a device provides wireless communication as shown and described herein. The operations or actions performed by the device can include the methods of any of the foregoing implementations.

The previously-described implementations are implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates a wireless network, according to some implementations.

FIG. 2 shows an example Medium Access Control (MAC) control element (CE) controlling cell activation or cell deactivation for a LTM switching procedure.

FIG. 3A shows an example MAC CE for TCI states for PDCCH for a deactivated target cell.

FIG. 3B shows an example MAC CE for TCI states for PUCCH or PUSCH for a deactivated target cell.

FIG. 4 shows an example MAC CE for a LTM switching procedure for target cell activation or deactivation.

FIG. 5 shows example fields for a cell switching command (CSC).

FIG. 6 illustrates a flowchart of an example method, according to some implementations.

FIG. 7 illustrates a flowchart of an example method, according to some implementations.

FIG. 8 illustrates a user equipment (UE), according to some implementations.

FIG. 9 illustrates an access node, according to some implementations.

### DETAILED DESCRIPTION

The devices, systems, and methods described in this document are configured for mobility enhancement for wireless devices, such as user equipment (UE) in wireless networks. Specifically, the methods described herein include cell handover command (e.g., a cell switching command) including particular fields (described in detail below) to manage cell switching during mobility scenarios. The command includes an enhanced Layer 1/Layer 2 (L 1/L2) Triggered Mobility (LTM) procedure to improve Layer 3 inter-cell mobility.

The systems and processes are configured to facilitate use of mobile services that rely on low-latency and high-reliability performance. For example, these include ultra-reliable low latency communications (URLLC) use cases. While the 5G standard has been designed to address these services from the start, the evolution of 5G New Radio (NR) enhances the mobility robustness performance for URLLC scenarios. The processes described herein include such enhancements. For example, the processes and systems are configured for Layer 1 (L1) enhancements for inter-cell beam management, including L1 measurement and reporting, and beam indication. The processes are based on the Rel-17 Inter-cell beam management (ICBM) channel state information (CSI) measurement process, which is used as a baseline. A use case for the LTM includes frequency range 2 (FR2) communications, in which there is a directional communication between the base station (e.g., a node or gNB) and a user equipment (UE) that is executing the LTM procedure. For example, such communications include specifying/selecting a particular beam for a target cell.

The systems and process are configured to indicate a Transmission Configuration Indicator (TCI) state for target cells in the LTM procedure. The TCI states are dynamically sent over in a downlink control information (DCI) message that includes configurations such as quasi-co-location (QCL) relationships between the downlink (DL) reference signals (RSs) in one channel state information reference signal (CSI-RS) set and the Physical Data Shared Channel (PDSCH) Demodulation Reference Signal (DMRS) ports. The UE can be configured with a list of up to “M” TCI-State configurations within the higher layer (RRC Re Config) parameter PDSCH-Config to decode PDSCH according to a detected PDCCH with DCI intended for the UE and the given serving cell. M depends on the UE capability maxNumberActiveTCI-PerBWP. Each TCI-State includes parameters for configuring a QCL relationship between one or two downlink reference signals and the DM-RS ports of the PDSCH, the DM-RS port of PDCCH or the CSI-RS port(s) of a CSI-RS resource. The quasi co-location (QCL) relationship is configured by the higher layer (e.g., RRC Reconfig) parameter qcl-Type1 for the first DL RS, and qcl-Type2 for the second DL RS, Maximum two qcl-types per TCI state can be configured.

The L1 enhancements of the systems and processes described herein are configured to provide several advantages. The LTM procedure is configured to indicate the beam information association with the target cells, without requiring configuration of all potential target TCI states. The processes described here are configured to overcome the drawback to Rel-17 ICBM, which relies on a configuration of all potential target TCI states for the serving cell and target cells (non-serving cells). The potential target cells include neighbor cells to the serving cell. Generally, Rel-17 ICBM does not consider mobility use scenarios. In some mobility use scenarios, the UE can be configured with a large number of TCI States for candidate cells measurement and significantly impact TCI states for the current intra-frequency serving cell. The LTM procedures described herein can overcome a factor in which there are limited number of TCI states available (e.g., 64). This factor is overcome because the LTM procedure does not configure all potential target TCI states. The LTM procedures described herein enable mobility scenarios because it does not require using TCI states for all neighboring cells (non-serving cells) or substantially reducing a number of TCI states available for the serving cell. The LTM procedures also enable mobility scenarios under Rel-18, in which a large number of target or neighboring cells are selected as candidates, without substantially reducing the available TCI states for the active serving cell.

The systems and processes specify functions and corresponding information fields to be indicated by the cell switching command. These fields enable the LTM procedure to use fewer TCI state identifiers, as previously described, and to reduce latency for cell switching, as subsequently described. These fields, described below, include the L1/L2 information that is used for cell handover.

The systems and processes are configured to avoid or reduce a latency caused after handover by the LTM procedure. The latency would be caused due to a periodic synchronization signal block (SSB) measurement on the target cell to achieve a time or frequency (T/F) synchronization requirement after LTM procedure. For example, one or more SSBs are periodically transmitted every 20 ms, introducing a delay caused by waiting for the next available SSB to perform T/F synchronization after LTM operation (e.g., 20 milliseconds due to SSB periodicity). The systems and processes for the LTM procedure described herein reduce a downlink (DL) synchronization and beam refinement latency for the Physical Data Shared Channel (PDSCH) by introducing an aperiodic signal triggered by the LTM procedure to ensure DL T/F synchronization and beam refinement occur with a minimal latency and therefore minimal impact on DL synchronization. As one example, assuming the aperiodic signal can be trigged by the LTM procedure signal, the latency can be reduced to 2 ms or 3 ms, which is significantly reduced compared to 20 ms latency in current system.

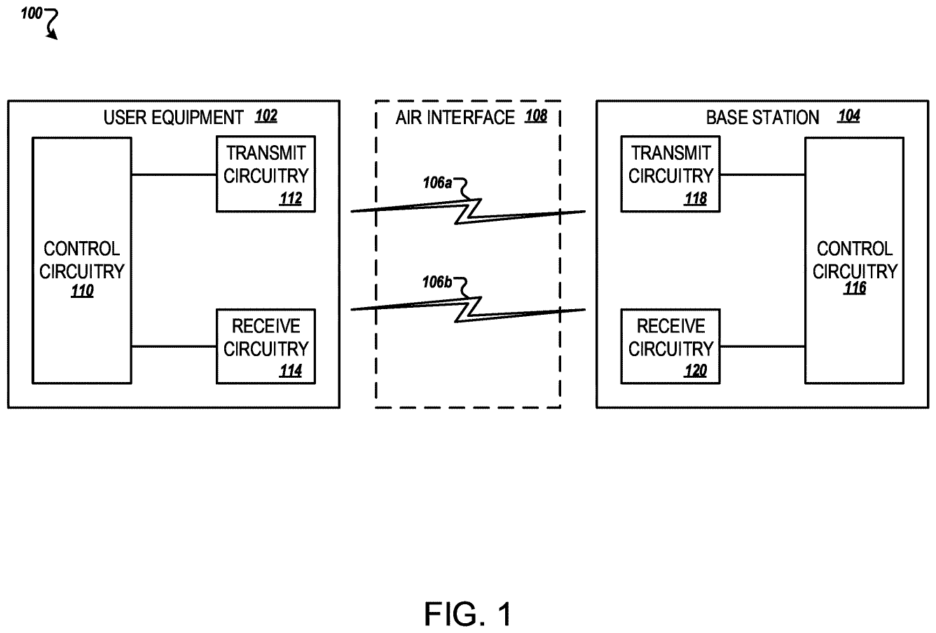

FIG. 1 illustrates a wireless network 100, according to some implementations. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 may be a Non-Standalone (NSA) network that incorporates Long Term Evolution (LTE) and Fifth Generation (5G) New Radio (NR) communication standards as defined by the Third Generation Partnership Project (3GPP) technical specifications. For example, the wireless network 100 may be an E-UTRA (Evolved Universal Terrestrial Radio Access)-NR Dual Connectivity (EN-DC) network, or a NR-EUTRA Dual Connectivity (NE-DC) network. However, the wireless network 100 may also be a Standalone (SA) network that incorporates only 5G NR. Furthermore, other types of communication standards are possible, including future 3GPP systems (e.g., Sixth Generation (6G)) systems, Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, laptop computers, smartphones, tablet computers, machine-type devices such as smart meters or specialized devices for healthcare, intelligent transportation systems, or any other wireless devices with or without a user interface. In network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider, or may be the Internet. Each base station service area associated with the base station 104 is supported by antennas integrated with the base station 104. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include various combinations of application-specific circuitry and baseband circuitry. The transmit circuitry 112 and receive circuitry 114 may be adapted to transmit and receive data, respectively, and may include radio frequency (RF) circuitry or front-end module (FEM) circuitry.

In various implementations, aspects of the transmit circuitry 112, receive circuitry 114, and control circuitry 110 may be integrated in various ways to implement the operations described herein. The control circuitry 110 may be adapted or configured to perform various operations such as those described elsewhere in this disclosure related to a UE. For instance, the control circuitry 110 can determine a transmission configuration indicator (TCI) state for a target cell, the TCI state specified in a medium access control (MAC) control element (CE) that identifies the target cell and a cell group of the target cell, the target cell being a candidate cell for a switch in a high mobility scenario. The control circuitry can be configured for activating a TCI state for the target cell based on the determined TCI state indicator of the MAC CE.

The transmit circuitry 112 can perform various operations described in this specification. For example, the transmit circuitry 112 can send a control switch command. Additionally, the transmit circuitry 112 may transmit a plurality of multiplexed uplink physical channels. The plurality of uplink physical channels may be multiplexed according to time division multiplexing (TDM) or frequency division multiplexing (FDM) along with carrier aggregation. The transmit circuitry 112 may be configured to receive block data from the control circuitry 110 for transmission across the air interface 108.

The receive circuitry 114 can perform various operations described in this specification. For instance, the receive circuitry 114 can receive a PDSCH or PDCCH transmission from the target cell based on the activated TCI state. Additionally, the receive circuitry 114 may receive a plurality of multiplexed downlink physical channels from the air interface 108 and relay the physical channels to the control circuitry 110. The plurality of downlink physical channels may be multiplexed according to TDM or FDM along with carrier aggregation. The transmit circuitry 112 and the receive circuitry 114 may transmit and receive both control data and content data (e.g., messages, images, video, etc.) structured within data blocks that are carried by the physical channels.

FIG. 1 also illustrates the base station 104. In implementations, the base station 104 may be an NG radio access network (RAN) or a 5G RAN, an E-UTRAN, a non-terrestrial cell, or a legacy RAN, such as a UTRAN or GERAN. As used herein, the term “NG RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108. The transmit circuitry 118 and receive circuitry 120 may be adapted to transmit and receive data, respectively, to any UE connected to the base station 104. The transmit circuitry 118 may transmit downlink physical channels includes of a plurality of downlink subframes. The receive circuitry 120 may receive a plurality of uplink physical channels from various UEs, including the UE 102.

In FIG. 1, the one or more channels 106A, 106B are illustrated as an air interface to enable communicative coupling, and can be consistent with cellular communications protocols, such as a GSM protocol, a CDMA network protocol, a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein. In implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Control Channel (PSCCH), a Physical Sidelink Discovery Channel (PSDCH), and a Physical Sidelink Broadcast Channel (PSBCH).

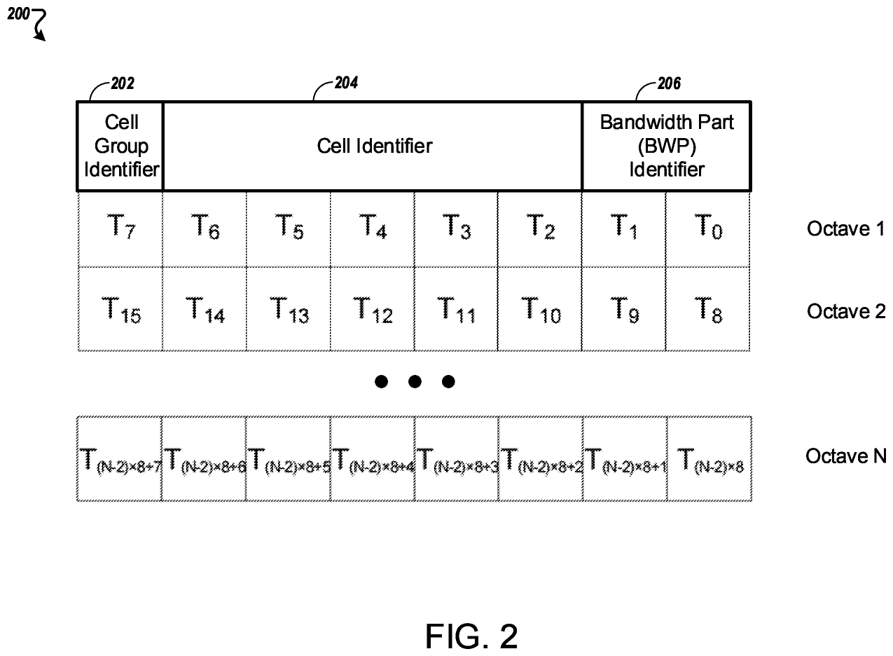

FIG. 2 shows an example MAC CE 200 configured for controlling cell activation or cell deactivation for a LTM switching procedure. Specifically, the MAC CE is configured for TCI state indication for target cells for the LTM Procedure. The MAC CE 200 includes a cell group identifier field 202 (also called a CG ID) field. The MAC CE 200 includes a cell identifier field 204. The MAC CE 200 includes a bandwidth part (BWP) identifier field 206. The MAC CE 200 is associated with a plurality of octaves 1−N, each including values for the TCI states, such as states T₀ to T_{((N-2)x8 30 7)}.

The MAC CE 200 is used with a LTM process, and is used to indicate the TCI state of candidate cells for L1/L2-triggered mobility. For the process that uses the MAC CE, a UE is configured with a list of TCI-states within each DL BWP of each candidate cell. The UE can be configured during a preparation phase for the LTM process.

Once the UE is configured, there are different options for indication of the TCI states for the target cell. A first option includes LTM that is supported based on a Rel-15 TCI framework. In the Rel-15 framework, the TCI state activation/deactivation is performed on a per physical channel/signal basis using different MAC-CE formats. For example, two different MAC-CE formats are specified and used to activate TCI-states associated with PDSCH and PDCCH channels independently. In this example, separate TCI states are configured and activated for PDCCH and PDSCH reception. The MAC CE 200 is introduced to activate or deactivate each of the TCI states for PDSCH channel on candidate cell groups, which can be designated by the cell group identifier field 202.

Additional fields are added to the MAC CE 200 for the LTM process for the PDSCH channel. The CG ID field 202 indicates the identity of the CG for which the MAC CE 200 is applicable. The cell ID field 204 indicates the cell identity in the cell group. The CG ID field 202 and the cell ID field 204 indicate the target cell for which the TCI state values are configured. For example, there can be several cell groups that do not include the serving cell, and each of these cell groups includes one or more cells. The CG ID field 202 refers to the target cell group, while the cell ID refers to the target cell within the selected cell group.

The BWP ID field 206 indicates a DL BWP for which the MAC CE 200 is applicable for the selected target cell of the selected target cell group. In some implementations, the BWP ID field 206 is not included, and a default BWP is pre-defined for each of the candidate cells. For example, a first active BWP that is configured by radio resource control (RRC) can be designated as being used for LTM operation.

Each of the TCI state fields of the octaves are marked by a value Tᵢ. The TCI state value is set to “1” to indicate that the TCI state corresponding to the TCI-State ID Tᵢ is to be activated and mapped to the codepoint of the downlink control information (DCI) TCI field. Generally, the MAC CE 200 can have a variable size that depends on the number of TCI states that are being configured. The size of the MAC CE is determined by number of octaves N. Note that the values for each TCI state are set to “1” or “0.”

The MAC CE 200 is one exemplified TCI state activation/deactivation MAC CE for LTM based on the Rel-15 framework. The MAC CE 200 is configured to support up to two candidate CGs configured for LTM. Each CG can be configured with up to 32 deactivated cells. To support more than 2 cell groups, a number of cells per candidate cell group can be reduced from 32 to 16. The cell group ID field 202 is therefore increased from 1 bit to 2 bits. The cell ID field 204 is correspondingly reduced from 5 bits to 4 bits to accommodate the larger CG ID field 202. The values of the TCI states are preconfigured for each target cell. During inter-mobility operation, the target cell ID is used to select the appreciate set of TCI state values.

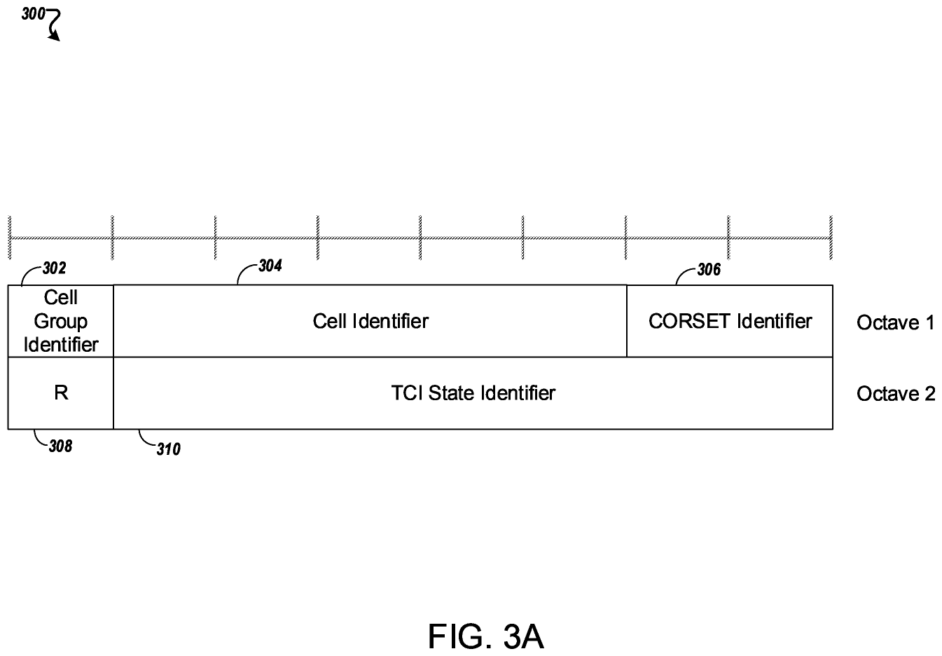

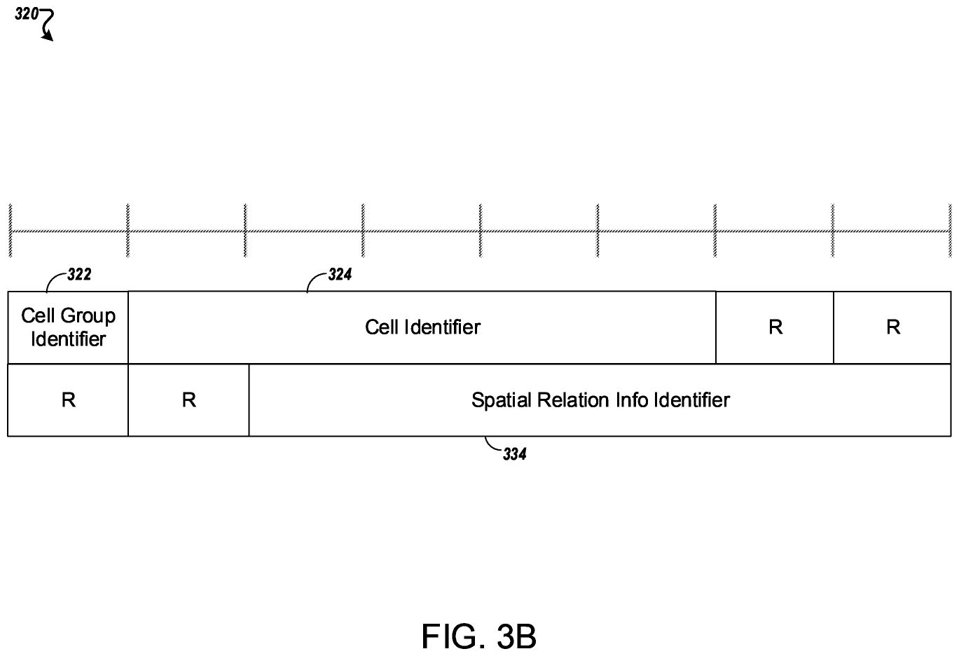

FIG. 3A shows an example MAC CE 300 for TCI states for PDCCH for a deactivated target cell. The MAC CE is configured for use within the REI-15 TCI framework. The MAC CE 300 includes a cell group identifier field 302, a cell identifier field 304, and a CORESET identifier field 306. The CG ID field 302 indicates the identity of the CG for which the MAC CE 300 is applicable. The CG identifier field 302 can be 1 bit, as shown, or extended to multiple bits, as described in relation to FIG. 2 for MAC CE 200. The cell ID field 304 indicates the cell identity in the cell group identified in CG ID field 302. The CG ID field 302 and the cell ID field 304 indicate the target cell for which the TCI state values are configured. For example, there can be several cell groups that do not include the serving cell, and each of these cell groups includes one or more cells. The CG ID field 302 refers to the target cell group, while the cell ID refers to the target cell within the selected cell group.

The CORESET identifier field 306 indicates a CORESET ID in a predefined BWP (e.g., a first active BWP) of the indicated cell. The CORESET ID can be a virtual ID. The virtual ID is defined by indexing the CORESET within a BWP of the indicated candidate cell. The CORSET ID includes 2 bits, as shown in FIG. 3A. The field R 308 is ‘reserved’ bit field and not used in this release. The TCI State ID field 310 indicates the TCI state ID that is configured by RRC signaling for the target cell.

FIG. 3B shows an example MAC CE 320 for TCI states for PUCCH or PUSCH for a deactivated target cell. The MAC CE 320 is configured for use within the REI-15 TCI framework. The MAC CE 320 includes a cell group identifier field 302, a cell identifier field 322, and a spatial relation info identifier field 334. The MAC CE 350 explicitly indicates the SRI data and is used in addition to MAC CEs 200, 300.

The CG ID field 322 indicates the identity of the CG for which the MAC CE 320 is applicable. The CG identifier field 322 can be 1 bit, as shown, or extended to multiple bits, as described in relation to FIG. 2 for MAC CE 200. The cell ID field 324 indicates the cell identity in the cell group identified in CG ID field 322. The CG ID field 324 and the cell ID field 322 indicate the target cell for which the TCI state values are configured. For example, there can be several cell groups that do not include the serving cell, and each of these cell groups includes one or more cells. The CG ID field 322 refers to the target cell group, while the cell ID refers to the target cell within the selected cell group.

The spatial relation information identifier (SRI) field 334 indicates, for PUCCH/PUSCH on the target cell, the SRI identity. The indicated SRI ID is commonly applied for both PUCCH and PUSCH transmission on a pre-defined BWP (such as a first uplink BWP). If the MAC CE 320 is not selected for use (e.g., MAC CE 200 or 300 are selected), the spatial setting for a PUCCH/PUSCH transmission from the UE is set as the same as a spatial setting for PDCCH receptions by the UE in the lowest CORESETs of the first active BWP during LTM operation. This occurs until UE receives a provided PUCCH SpatialRelationInfo (SRI) from network after LTM procedure. In these scenarios, UL/DL beam reciprocity is assumed such that it is assumed that the UL beam that is used for transmission is the same as the selected DL beam by the UE. In this case, the UL SRI need not be indicated.

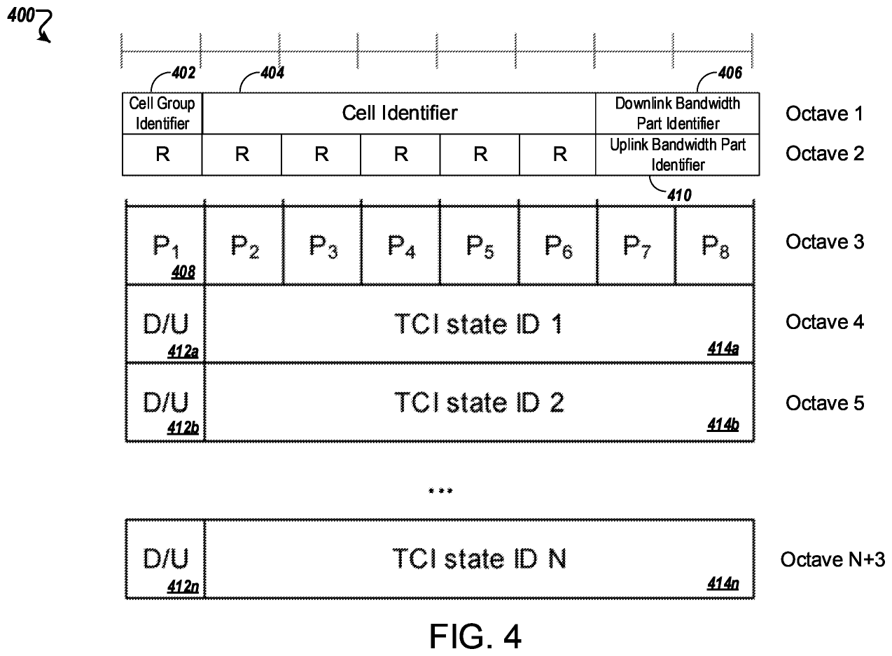

FIG. 4 shows an example MAC CE 400 for a LTM switching procedure for target cell activation or deactivation. For Rel-17, a unified TCI framework is used. For one direction (e.g., DL TCI states), a single TCI state applies for all DL channels, such as the PDSCH and the PDCCH. This is intended to simplify TCI indication. The following fields maybe provided in the enhanced Activation/Deactivation MAC CE 400 for a target cell. A CG ID field 402 indicates an identity of the cell group for which the MAC CE 400 applies. The CG identifier field 402 can be 1 bit, as shown, or extended to multiple bits, as described in relation to FIG. 2 for MAC CE 200. The cell ID field 404 indicates a cell ID in the cell group. The DL BWP identifier field 406 or the UL BWP identifier field 410 indicates a DL BWP or UL BWP ID for which the MAC CE 400 applies. The Pᵢ field 408 indicates whether each TCI codepoint has multiple TCI states or single TCI state. The Pᵢ field is 1 bit. The D/U field 412a-n indicates whether the TCI state ID in the same octet is for joint/downlink or uplink TCI state. The TCI state ID field 414a-n indicates a TCI state ID that is associated with Nth codepoint of the TCI field. The MAC CE 400 can be variable size, similar to MAC CE 200, depending on the number of D/U fields 412n and the number of TCI state ID fields 414n. In some implementations, a number N of activated TCI-states for deactivated candidate cells in LTM can be reported as part of the UE capability signaling.

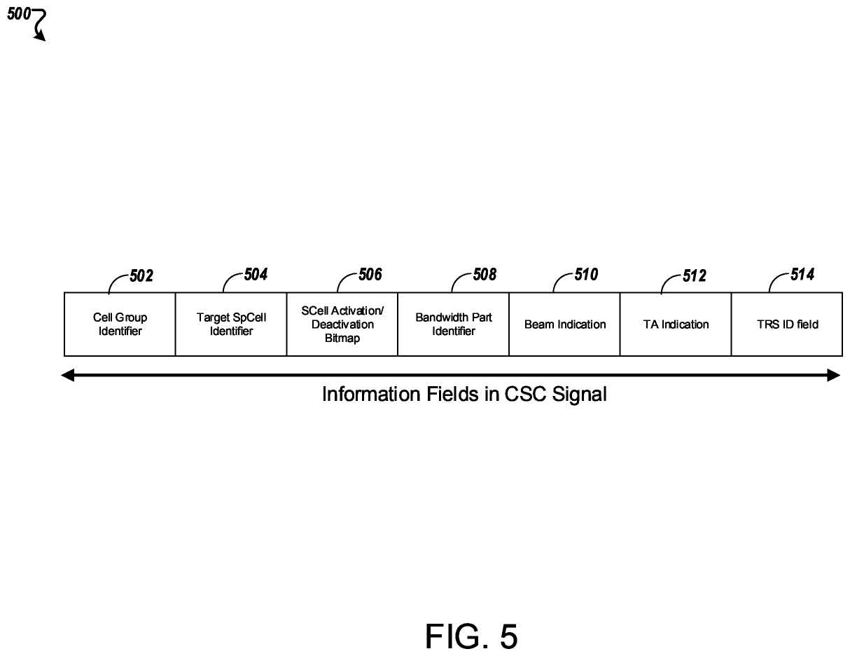

FIG. 5 shows example fields 502, 504, 506, 508, 510, 512, and 514 for a cell switching command (CSC) 500. A variety of information can be transmitted in the cell switching command (CSC) 500. The CSC command can include a new MAC CE or DCI Format. In the following example, a MAC CE is described, but this can instead use the DCI format. The CG identifier field 502 indicates an identity of the cell group for which LTM procedure is triggered and applied. The target SpCell identifier field 504 indicates a target SpCell ID in the indicated cell group of field 502. In some implementations, one SpCell is pre-configured for each cell group during the LTM preparation phase and before triggering the LTM operation. The target cell identifier field can be omitted included in the CSC command 500. The RRC-configured SpCell in the target cell group becomes the SpCell once the LTM operations are completed.

The CSC command 500 includes a SCell Activation/Deactivation bitmap field 506. The bitmap field 506 indicates an activation or deactivation of the cells in the indicated cell group 502. The BWP identifier field 508 is configured according to one of the following options. For a first option, the BWO ID field 508 indicates an identity of the BWP that is applied on the indicated target SpCell ID of field 504 for the LTM operation. In a second option, the field 508 indicates multiple BWP IDs that are included. Each BWP ID is associated with one activated cell. In a third option, a first active DL BWP and a first active UL BWP are configured by RRC signaling during a preparation phase that is applied for LTM operations. In this example, the BWP ID field 508 is omitted from the CSC command 500. For a fourth option, RRC signaling is introduced to indicate a presence of a BWP ID in the CSC command 500, which provides flexibility for network between signaling overhead and LTM operation flexibility.

The CSC command 500 includes a beam indication (BI) field 510. For the beam indication field 510, there are several different options that are available regarding a number of BI fields. In a first option, one BI field is applied for the SpCell in the candidate cell group. In a second option, multiple BI fields are applied, and each BI is applied for a cell in a cell group specified by field 502.

Generally, various approaches can be considered to indicate the beam information for target cells to be applied after the LTM operations. In a first option, one TCI field can be included in a CSC command 500 signal to indicate one TCI State from multiple TCI states activated by a MAC-CE or one SRI value, as previously described. In a second option, a reference signal (RS) can be indicated. The RS is within a set of reference signals that is used for LI measurement reporting (including SSB or CSI-RS) as part of the LTM operations. The RS is used as a QCL source for both DL reception and UL transmission. In a third option, a contention free random access (CFRA) configuration index is included in the CSC command 500 signal. The CSC command 500 includes an SSB index. The indicated SSB is used as QCL source RS for both DL reception and UL transmission.

The CSC includes a timing Advance (TA) indication field 512. There are several options for indication of the timing advance. In a first option, a TA value or TAG Index is directly included in a CSC command 500, as shown in FIG. 5. In a second option, a CFRA-based procedure is used to acquire TA value during the LTM procedure. The CFRA-based procedure includes the following steps. First during the LTM preparation phase, a UE is provided a set of CFRA configurations by RRC signaling on the SpCell in each CG as part of CG configuration. Second, a CFRA configuration index that is on the SpCell of the indicated cell group is included in a CSC command or a separate MAC-CE to trigger CFRA procedure and to acquire the TA value. In some implementations, the CFRA can be triggered PRACH transmissions on a deactivated SCell or deactivated non-serving cell for TA acquisition purpose.

In a third option, a TA value is derived based on TCI State or CG ID indicted by the CSC command. In some implementations, each UL TCI state or SRI was associated with a TAG by RRC signaling. The UE may then derive the TA value based on the UL TCI State indicated by BI field. In some implementations, a TAG is assigned for each candidate cell group. Based on the indicated cell group ID, the UE derives the corresponding TA value.

In a fourth option, a presence of the TA field 512 in the CSC command 500 is configured by RRC signaling. If not present, RRC signaling will indicate one of a set of pre-defined candidate values, including a value of TA=0 or a value that is a same TA value as the current intra-frequency serving cell.

In a fifth option, based on the UE capability, the network enables UE-based TA computation for the target CG based on a receive (Rx) timing difference between the serving cell and the target cell. Correspondingly, an indicator is included in CSC command 500 signaling to indicate whether to use the UE-derived TA for the LTM procedure. A maximum number of TAGs per frequency layer is reported as part of UE capability reporting.

In some implementations, the CSC command 500 includes a tracking reference signal (TRS) field 514. The TRS field is used to configure aperiodic TRS triggering for the LTM procedure. In this example, to enable a fast T/F refinement after LTM operation, one or more sets of aperiodic Tracking RS (TRS) are configured for a candidate cell in a cell group and triggered by the CSC command 500 signal to assist Automatic Gain Control (AGC) setting and time/frequency synchronization. The process includes two steps. In a first step, the UE is provided one or multiple TRS resource set bursts for each cell or for a SpCell only in a candidate cell group. Generally, each TRS resource set includes of N TRS bursts, where N is configured by RRC signaling. The gap between the bursts of TRS resource sets is configured by a separate RRC parameter in units of slots. In some implementations, a default value is pre-determined and used when the gap field is absent. The QCL source is explicitly configured by referring to SSB or periodic CSI-RS configured on the target cell. Each TRS resource set burst configuration is identified by a TRS-ID.

In a second step, one TRS request field 514 is included in the CSC command 500 signal. The TRS request field 514 triggers an aperiodic TRS burst transmission for the target cells in a cell group. If the TRS-ID field in CSC command 500 signal is set to a non-zero value, the corresponding TRS addressed by the TRS-ID is triggered. The triggering offset between the slot of the CSC command 500 signal and the slot in which the TRS resource set is transmitted is configured by RRC based on the UE capability report. To minimize the signaling overhead, the triggered TRS by CSC signal is limited to be within the first active BWP of the cells to be activated SCells in the target cell group. In some implementations, an application time for CSC signal application is defined relative to the HARQ-ACK feedback of the CSC signal. In some implementations, different TRS values are defined for different subcarrier spacing (SCS) values. For example, two slots maybe defined for 15 kilohertz (kHz) SCS. While a larger value e.g., four slots maybe defined for 30 kHz SCS case due to a smaller slot duration compared to 15 kHz SCS.

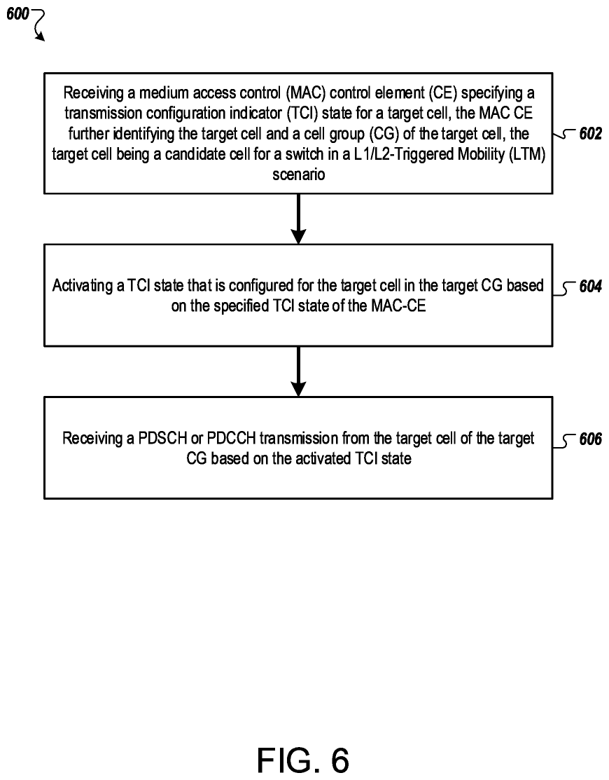

FIG. 6 illustrates a flowchart of an example method 600, according to some implementations. For clarity of presentation, the description that follows generally describes method V100 in the context of the other figures in this description. For example, method 600 can be performed by UE 100 of FIG. 1. It will be understood that method 600 can be performed, for example, by any suitable system, environment, software, hardware, or a combination of systems, environments, software, and hardware, as appropriate. In some implementations, various steps of method 600 can be run in parallel, in combination, in loops, or in any order.

The method 600 includes receiving (602) a medium access control (MAC) control element (CE) specifying a transmission configuration indicator (TCI) state for a target cell, the MAC CE further identifying the target cell and a cell group (CG) of the target cell, the target cell being a candidate cell for a switch in a L1/L2-Triggered Mobility (LTM) scenario. The method 600 includes activating (604) a TCI state that is configured for the target cell in the target CG based on the specified TCI state of the MAC-CE. The method 600 includes receiving (606) a PDSCH or PDCCH transmission from the target cell of the target CG based on the activated TCI state. In some implementations, the MAC CE comprises a bitmap that specifies, for each bit of the bitmap, activation of the TCI state with a TCI state identifier value corresponding to the index of that bit in the bitmap, the activation comprising mapping the activated TCI state with the TCI state identifier value to a codepoint of TCI field in a downlink control information (DCI). In some implementations, the MAC CE comprises a bandwidth part identifier that indicates a downlink bandwidth part of the target cell for which the MAC CE is applicable. In some implementations, the MAC CE is used to support activating one or more TCI states for a target cell when at least two candidate cell groups are configured for LTM scenario, each candidate cell group comprising up to 32 deactivated candidate target cells. In some implementations, the MAC CE is used to support activating one or more TCI states for a target cell when at least four candidate cell groups are configured for LTM procedure, each candidate cell group comprising up to 16 deactivated candidate target cells.

In some implementations, the MAC CE comprises a CORESET ID field that indicates a CORESET identifier value for a predefined BWP for the target cell. In some implementations, the MAC CE comprises a TCI state ID field, wherein the TCI state ID is configured by radio resource control (RRC) signaling for the target cell. In some implementations, the TCI state ID field is 7 bits.

In some implementations, a spatial setting for a PUCCH/PUSCH transmission from a UE matches a spatial setting for PDCCH receptions at the UE in the lowest CORESETs of a first active BWP during a L1/L2 triggered mobility (LTM) operation. In some implementations, the MAC CE comprises a spatial relation information (SRI) field that specifies spatial relation information for a PUCCH resource for transmission by a UE. In some implementations, the MAC CE comprises: a BWP ID field that indicates a BWP where the MAC-CE is applied; and a TCI state identifier field that indicates a TCI state associated with a given codepoint of a TCI field and applied for the indicated BWP, the TCI identifier field being associated with an DL or UL field that indicates whether the TCI state is associated with a downlink TCI state or an uplink TCI state. In some implementations, the MAC CE comprises a P field that indicates whether the given codepoint is associated with a single TCI state or multiple TCI states.

In some implementations, the process 600 includes triggering a cell switch based on a cell switching command (CSC), the cell switching command comprising a cell group identifier field indicating a cell group, and a target SpCell identifier field indicating the target SpCell in the cell group. In some implementations, the CSC further comprises a bitmap field indicating the activation or deactivation of each cell in the cell group; and a BWP ID field indicating an identity of at least one bandwidth part that is applied on the indicated target SpCell for LTM operation. In some implementations, a first active downlink BWP and a first active uplink BWP that are configured by RRC signaling during a preparation phase for LTM operation are used during and after LTM operation for communication with the target cell.

In some implementations, the CSC further comprises a beam information field applied for the SpCell in the cell group that is identified. In some implementations, the beam information field indicates a TCI state from one or more activated TCI states associated with the target cell. In some implementations, the beam information field indicates a Reference Signal (RS) index from one or more RSs that is used for target cell measurement and report.

In some implementations, the CSC further comprising a timing advance field that includes a timing advance (TA) value or time advance group (TAG) value. In some implementations, the process 600 includes providing, to a UE, a set of contention free random access (CFRA) configurations by RRC signaling on a SpCell in each cell group as part of a cell group configuration. The process 600 includes providing, in a CSC to the UE, a CFRA configuration index for a SpCell of the cell group. The process 600 includes triggering a CFRA procedure based on the CFRA configuration associated with the indicated CFRA configuration index to acquire a timing advance value during the LTM operation.

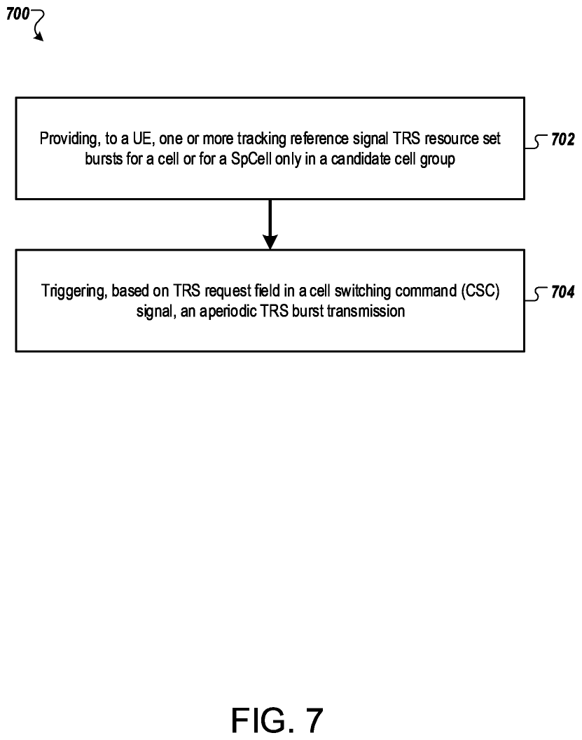

FIG. 7 illustrates a flowchart of an example method 700, according to some implementations. For clarity of presentation, the description that follows generally describes method 700 in the context of the other figures in this description. For example, method 700 can be performed by UE 100 of FIG. 1. It will be understood that method 700 can be performed, for example, by any suitable system, environment, software, hardware, or a combination of systems, environments, software, and hardware, as appropriate. In some implementations, various steps of method 700 can be run in parallel, in combination, in loops, or in any order.

The method 700 includes providing (702), to a UE, a set of contention free random access (CFRA) configurations by RRC signaling on a SpCell in each cell group as part of a cell group configuration. The method 700 includes providing (704), in a CSC by the UE, a CFRA configuration index for a SpCell of the cell group, the CFRA configuration index configured to trigger a CFRA procedure to acquire a timing advance value. In some implementations, the TRS request field includes a non-zero value that indicates a TRS ID that specifies the TRS resource burst transmission that is triggered. In some implementations, a gap between bursts of the TRS resource sets is configured by a separate radio resource control parameter in a unit of slots. In some implementations, a triggering offset, between a slot of the CSC signal and a slot in which the TRS resource set burst is transmitted, is configured by RRC based on a UE capability report.

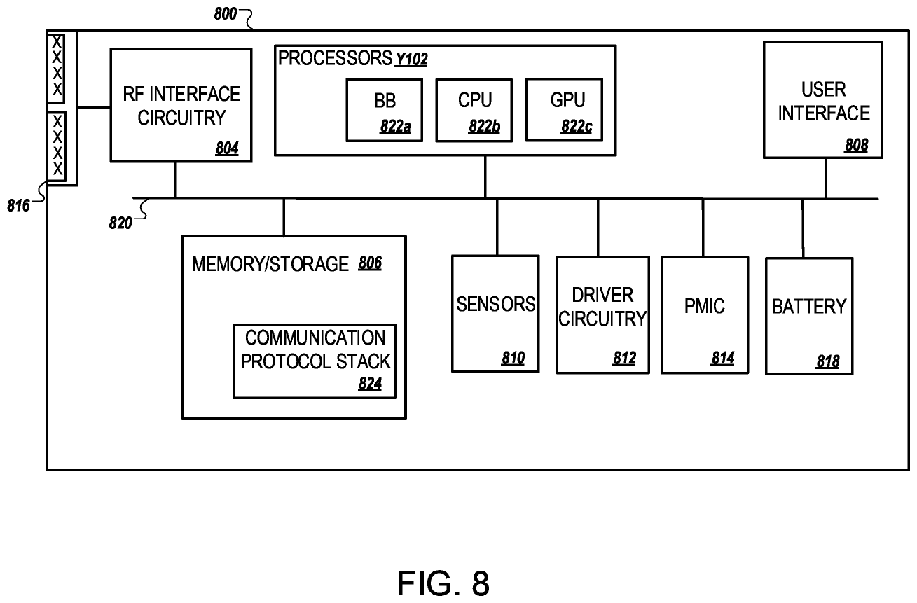

FIG. 8 illustrates a UE 800, according to some implementations. The UE 800 may be similar to and substantially interchangeable with UE 102 of FIG. 1.

The UE 800 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 800 may include processors 802, RF interface circuitry 804, memory/storage 806, user interface 808, sensors 810, driver circuitry 812, power management integrated circuit (PMIC) 814, antenna structure 816, and battery 818. The components of the UE 800 may be implemented as integrated circuits (ICs), portions thereof, discrete electronic devices, or other modules, logic, hardware, software, firmware, or a combination thereof. The block diagram of FIG. 8 is intended to show a high-level view of some of the components of the UE 800. However, some of the components shown may be omitted, additional components may be present, and different arrangement of the components shown may occur in other implementations.

The components of the UE 800 may be coupled with various other components over one or more interconnects 820, which may represent any type of interface, input/output, bus (local, system, or expansion), transmission line, trace, optical connection, etc. that allows various circuit components (on common or different chips or chipsets) to interact with one another.

The processors 802 may include processor circuitry such as, for example, baseband processor circuitry (BB) 822A, central processor unit circuitry (CPU) 822B, and graphics processor unit circuitry (GPU) 822C. The processors 802 may include any type of circuitry or processor circuitry that executes or otherwise operates computer-executable instructions, such as program code, software modules, or functional processes from memory/storage 806 to cause the UE 800 to perform operations as described herein.

In some implementations, the baseband processor circuitry 822A may access a communication protocol stack 824 in the memory/storage 806 to communicate over a 3GPP compatible network. In general, the baseband processor circuitry 822A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 804. The baseband processor circuitry 822A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 806 may include one or more non-transitory, computer-readable media that includes instructions (for example, communication protocol stack 824) that may be executed by one or more of the processors 802 to cause the UE 800 to perform various operations described herein. The memory/storage 806 include any type of volatile or non-volatile memory that may be distributed throughout the UE 800. In some implementations, some of the memory/storage 806 may be located on the processors 802 themselves (for example, L1 and L2 cache), while other memory/storage 806 is external to the processors 802 but accessible thereto via a memory interface. The memory/storage 806 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 804 may include transceiver circuitry and radio frequency front module (RFEM) that allows the UE 800 to communicate with other devices over a radio access network. The RF interface circuitry 804 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 816 and proceed to filter and amplify (with a low-noise amplifier) the signal. The signal may be provided to a receiver of the transceiver that downconverts the RF signal into a baseband signal that is provided to the baseband processor of the processors 802.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 816. In various implementations, the RF interface circuitry 804 may be configured to transmit/receive signals in a manner compatible with NR access technologies.

The antenna 816 may include antenna elements to convert electrical signals into radio waves to travel through the air and to convert received radio waves into electrical signals. The antenna elements may be arranged into one or more antenna panels. The antenna 816 may have antenna panels that are omnidirectional, directional, or a combination thereof to enable beamforming and multiple input, multiple output communications. The antenna 816 may include microstrip antennas, printed antennas fabricated on the surface of one or more printed circuit boards, patch antennas, phased array antennas, etc. The antenna 816 may have one or more panels designed for specific frequency bands including bands in FR1 or FR2.

The user interface 808 includes various input/output (I/O) devices designed to enable user interaction with the UE 800. The user interface 808 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 800.

The sensors 810 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 812 may include software and hardware elements that operate to control particular devices that are embedded in the UE 800, attached to the UE 800, or otherwise communicatively coupled with the UE 800. The driver circuitry 812 may include individual drivers allowing other components to interact with or control various input/output (I/O) devices that may be present within, or connected to, the UE 800. For example, driver circuitry 812 may include a display driver to control and allow access to a display device, a touchscreen driver to control and allow access to a touchscreen interface, sensor drivers to obtain sensor readings of sensor circuitry 810 and control and allow access to sensor circuitry 810, drivers to obtain actuator positions of electro-mechanic components or control and allow access to the electro-mechanic components, a camera driver to control and allow access to an embedded image capture device, audio drivers to control and allow access to one or more audio devices.

The PMIC 814 may manage power provided to various components of the UE 800. In particular, with respect to the processors 802, the PMIC 814 may control power-source selection, voltage scaling, battery charging, or DC-to-DC conversion.

In some implementations, the PMIC 814 may control, or otherwise be part of, various power saving mechanisms of the UE 800. A battery 818 may power the UE 800, although in some examples the UE 800 may be mounted deployed in a fixed location, and may have a power supply coupled to an electrical grid. The battery 818 may be a lithium ion battery, a metal-air battery, such as a zinc-air battery, an aluminum-air battery, a lithium-air battery, and the like. In some implementations, such as in vehicle-based applications, the battery 818 may be a typical lead-acid automotive battery.

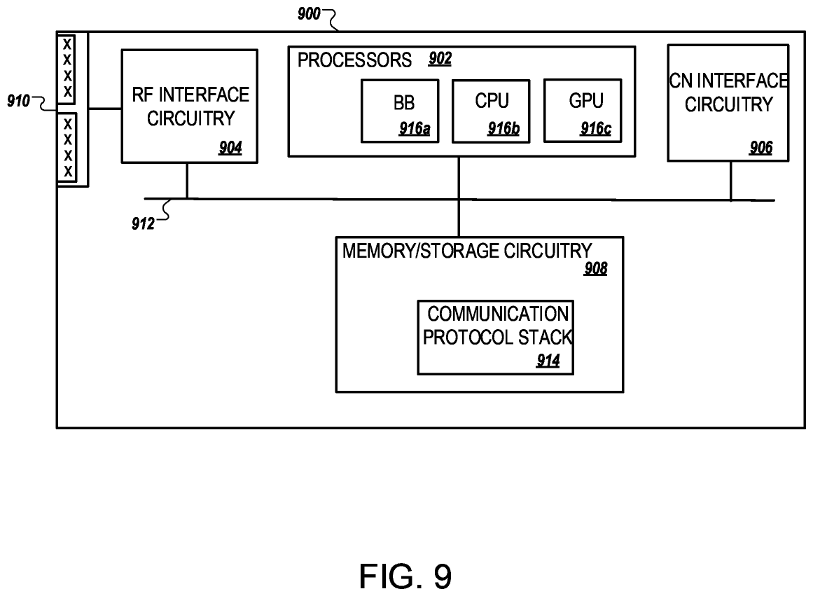

FIG. 9 illustrates an access node 900 (e.g., a base station or gNB), according to some implementations. The access node 900 may be similar to and substantially interchangeable with base station 104. The access node 900 may include processors 902, RF interface circuitry 904, core network (CN) interface circuitry 906, memory/storage circuitry 908, and antenna structure 910.

The components of the access node 900 may be coupled with various other components over one or more interconnects 912. The processors 902, RF interface circuitry 904, memory/storage circuitry 908 (including communication protocol stack 914), antenna structure 910, and interconnects 912 may be similar to like-named elements shown and described with respect to FIG. 8. For example, the processors 902 may include processor circuitry such as, for example, baseband processor circuitry (BB) 916A, central processor unit circuitry (CPU) 916B, and graphics processor unit circuitry (GPU) 916C.

The CN interface circuitry 906 may provide connectivity to a core network, for example, a 5th Generation Core network (5GC) using a 5GC-compatible network interface protocol such as carrier Ethernet protocols, or some other suitable protocol. Network connectivity may be provided to/from the access node 900 via a fiber optic or wireless backhaul. The CN interface circuitry 906 may include one or more dedicated processors or FPGAs to communicate using one or more of the aforementioned protocols. In some implementations, the CN interface circuitry 906 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 900 that operates in an NR or 5G system (for example, a gNB), and the term “E-UTRAN node” or the like may refer to an access node 900 that operates in an LTE or 4G system (e.g., an eNB). According to various implementations, the access node 900 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 900 may be implemented as one or more software entities running on server computers as part of a virtual network, which may be referred to as a CRAN and/or a virtual baseband unit pool (vBBUP). In V2X scenarios, the access node 900 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1-24. (canceled)

25. One or more processors configured to perform operations for wireless communication, the operations comprising:
receiving a medium access control (MAC) control element (CE) specifying a transmission configuration indicator (TCI) state for a target cell, the MAC CE further identifying the target cell and a cell group (CG) of the target cell, the target cell being a candidate cell for a switch in a L1/L2-Triggered Mobility (LTM) operation;
activating a TCI state that is configured for the target cell in the target CG based on the specified TCI state of the MAC-CE; and
receiving a PDSCH or PDCCH transmission from the target cell of the target CG based on the activated TCI state.

26. The one or more processors of claim 25, wherein the MAC CE comprises a bitmap that specifies, for each bit of the bitmap, activation of the TCI state with a TCI state identifier value corresponding to an index of that bit in the bitmap, the activation comprising mapping the activated TCI state with the TCI state identifier value to a codepoint of TCI field in a downlink control information (DCI).

27. The one or more processors of claim 25, wherein the MAC CE comprises a bandwidth part identifier that indicates a downlink bandwidth part of the target cell for which the MAC CE is applicable.

28. The one or more processors of claim 25, wherein the MAC CE is used to support activating one or more TCI states for a target cell when at least two candidate cell groups are configured for LTM operation, each candidate cell group comprising up to 32 deactivated candidate target cells.

29. The one or more processors of claim 25, wherein the MAC CE is used to support activating one or more TCI states for a target cell when at least four candidate cell groups are configured for LTM operation, each candidate cell group comprising up to 16 deactivated candidate target cells.

30. The one or more processors of claim 25, wherein the MAC CE comprises a CORESET ID field that indicates a CORESET identifier value for a predefined BWP for the target cell.

31. The one or more processors of claim 25, wherein a spatial setting for a PUCCH/PUSCH transmission from a UE matches a spatial setting for PDCCH receptions at the UE in the lowest CORESETs of a first active BWP during a L1/L2 triggered mobility (LTM) operation.

32. The one or more processors of claim 25, wherein the MAC CE comprises a spatial relation information (SRI) field that specifies spatial relation information for a PUCCH resource for transmission by a UE.

33. The one or more processors of claim 25, wherein the MAC CE comprises:
a candidate cell identifier filed that indicates a cell identifier in a code group; and
a TCI state identifier field that indicates a TCI state associated with a given codepoint of a TCI field, the TCI identifier field being associated with an DL or UL field that indicates whether the TCI state is associated with a downlink TCI state or an uplink TCI state.

34. The one or more processors of claim 33, wherein the MAC CE comprises a P field that indicates whether the given codepoint is associated with a single TCI state or multiple TCI states.

35. The one or more processors of claim 25, further comprising:
triggering a cell switch based on a cell switching command (CSC), the cell switching command comprising a cell group identifier field indicating a cell group, and a target SpCell identifier field indicating the target SpCell in the cell group.

36. The one or more processors of claim 35, the CSC further comprising
a bitmap field indicating the activation or deactivation of each cell in the cell group; and
a BWP ID field indicating an identity of at least one bandwidth part that is applied on the indicated target SpCell for LTM operation.

37. The one or more processors of claim 35, wherein a first active downlink BWP and a first active uplink BWP that are configured by RRC signaling during a preparation phase for LTM operation are used during and after LTM operation for communication with the target cell.

38. The one or more processors of claim 35, the CSC further comprising a beam information field applied for the SpCell in the cell group that is identified.

39. The one or more processors of claim 38, wherein the beam information field indicates a TCI state from one or more activated TCI states associated with the target cell or wherein the beam information indicates a spatial relation information (SRI) value.

40. The one or more processors of claim 35, the CSC further comprising a timing advance field that includes a timing advance (TA) value or time advance group (TAG) value.

41. The one or more processors of claim 25, further comprising:
providing, to a UE, a set of contention free random access (CFRA) configurations by RRC signaling on a SpCell in each cell group as part of a cell group configuration; and
providing, in a CSC to the UE, a CFRA configuration index for a SpCell of the cell group; and
triggering a CFRA procedure based on the CFRA configuration associated with the indicated CFRA configuration index to acquire a timing advance value during LTM operation.

42. A method comprising:
providing, to a UE, one or more tracking reference signal TRS resource set bursts for a cell or for a SpCell only in a candidate cell group; and
triggering, based on TRS request field in a cell switching command (CSC) signal, an aperiodic TRS burst transmission.

43. The method of claim 42, wherein the TRS request field includes a non-zero value that indicates a TRS ID that specifies the TRS resource burst transmission that is triggered;
wherein a gap between bursts of the TRS resource sets is configured by a separate radio resource control parameter in a unit of slots; and
wherein a triggering offset, between a slot of the CSC signal and a slot in which the TRS resource set burst is transmitted, is configured by RRC based on a UE capability report.

44. A method comprising:
receiving a medium access control (MAC) control element (CE) specifying a transmission configuration indicator (TCI) state for a target cell, the MAC CE further identifying the target cell and a cell group (CG) of the target cell, the target cell being a candidate cell for a switch in a L1/L2-Triggered Mobility (LTM) operation;
activating a TCI state that is configured for the target cell in the target CG based on the specified TCI state of the MAC-CE; and
receiving a PDSCH or PDCCH transmission from the target cell of the target CG based on the activated TCI state.
